(19) United States
(12) Patent Application Publication
(10) Pub. No.: US 2010/0039565 A1
(43) Pub. Date: Feb. 18, 2010

(54) Scene Change Detector

(76) Inventor: Patrick Seeling, Stevens Point, WI (US)

Correspondence Address: BOYLE FREDRICKSON S.C., 840 North Plankinton Avenue, MILWAUKEE, WI, 53203, US

(21) Appl. No.: 12/542,429

(22) Filed: Aug. 17, 2009

Related U.S. Application Data
(60) Provisional application No. 61/089,760, filed on Aug. 18, 2008.

(51) Int. Cl. H04N 5/14

(52) U.S. Cl. 348/702; 348/E05.067

(57) ABSTRACT

A scene change detector provides automatic detection of scene changes by utilizing frame-to-frame differences in chrominance components of video frames analyzed for information content.

### CROSS REFERENCE TO RELATED APPLICATIONS

This application claims the benefit of U.S. provisional application 61/089,760 filed Aug. 18, 2008 hereby incorporated in its entirety by reference.

### BACKGROUND OF THE INVENTION

The present invention relates to systems for detecting changes in scenes in video and, in particular, to an improved method of automatically detecting changes in scenes in a series of uncompressed video frames.

Video is typically stored as a sequence of time ordered frames, each frame essentially being a still image comprised of picture elements (pixels) providing values of the image over a rectilinear grid. The pixel values may, for example, be encoded in RGB format, where each pixel value is an ordered triplet providing the perceived brightness of a red, blue, or green component, or Y′UV encoded where each pixel value is an ordered triplet, the first describing a monochromatic luminance of the pixel and the latter two providing a vector indicating a chrominance or color value of the pixel. Y′UV encoding takes advantage of a decreased spatial sensitivity of human vision to color to decrease the information depth of the chrominance components with respect to luminance components.

It is often desired to be able to separate a video file into scenes, a scene generally representing an abrupt change in the video image as a result of a change in camera orientation. Scenes constitute the fundamental element used for video editing and therefore are useful as a prelude to such editing. In addition, scenes generally follow a logical division of the information presented by the video and therefore can be used to catalog or index the video, for example, by capturing a single representative frame from each scene.

Automated systems for detecting changes in scenes are often fooled by sudden shifts in the brightness of the image or by changes in a portion of the image in which no scene change has occurred.

### SUMMARY OF THE INVENTION

The present inventors have determined that improved automatic scene detection can be obtained by looking not at the brightness of the video image but rather at changes in its color components. In particular, for uncompressed video in the Y′UV format, the present invention may review a single chrominance component (U or V).

Specifically then, the present invention provides a scene change detector for video receiving a color video signal of time ordered frames of pixels providing luminance and chrominance components. A chrominance extractor extracts a selected chrominance component from the frames to produce chrominance frames without luminance information. Next, an information change detector receives a sequence of chrominance frames to output a scene change signal based on changes between sequential chrominance frames.

It is thus a feature of at least one embodiment of the invention to provide a scene change detector operating on the insight that scene change information is accentuated in chrominance signals. It is a feature at least one embodiment of the invention to provide a scene change detector that may work efficiently as a reduced data set represented by a single chrominance signal.

The information change detector may measure the information content of a difference between sequential frames.

It is thus a feature of at least one embodiment of the invention to analyze frame-to-frame chrominance changes to reduce the data that must be analyzed for information content.

The measure of information content may be entropy.

It is thus a feature of at least one embodiment of the invention to simply quantify information content.

The information change detector provides an output that is a function of a change in changes of sequential chrominance frames.

It is thus a feature of at least one embodiment of the invention to accentuate change sensitivity.

The chrominance signal is the U chrominance signal.

It is thus a feature of at least one embodiment of the invention to select a chrominance component that may be particularly sensitive to scene changes.

The color video signal may be uncompressed.

It is thus a feature of at least one embodiment of the invention to provide a system that may operate on a real-time basis with raw video data.

The information change detector further may further include a comparator comparing a change in a value of a function of information content of a difference between frames to a threshold value set to provide a predetermined number of scene changes per a time interval.

It is thus a feature of at least one embodiment of the invention to provide a single parameter that may be simply adjusted to correct for a variety of different video media content.

The scene change detector may further include a display for displaying the threshold value juxtaposed on a time plot of the function and including a control for varying the threshold value to visually move the threshold value with respect to the plot of the function.

It is thus a feature of at least one embodiment of the invention to provide a simple user interface compatible with the present invention.

These particular features and advantages may apply to only some embodiments falling within the claims and thus do not define the scope of the invention.

### BRIEF DESCRIPTION OF THE DRAWINGS

FIG. 1 is a block diagram of the video scene change detector of the present invention showing a chrominance extractor and a change detector;

FIG. 2 is a block diagram of the change detector of FIG. 1 showing differencing circuits and an entropy processor;

FIG. 3 is a block diagram of the entropy processor of FIG. 2;

FIGS. 4a and 4b are block diagrams of the differencing circuits of FIG. 2;

FIG. 5 depicts a display provided by the present invention for setting various threshold levels; and

FIG. 6 is a block diagram of a standard computer system such as may implement the present invention.

### DETAILED DESCRIPTION OF THE PREFERRED EMBODIMENT

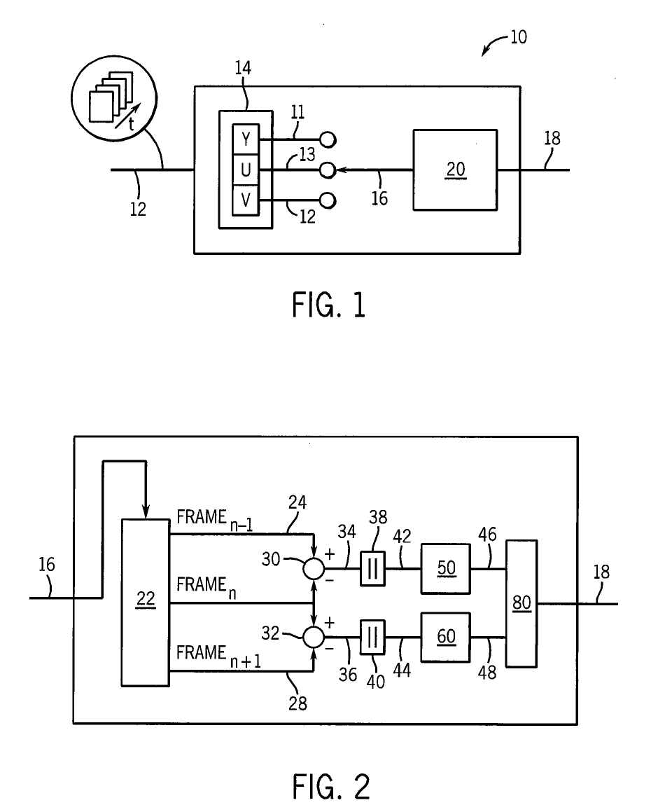

Referring now to FIG. 1, a video scene change detector 10 of the present invention may receive an uncompressed color video signal 12, for example, from a video camera or a local or remote video storage device. In one embodiment, the color video signal 12 is in the Y′UV format providing a separate luminance signal 11 (Y), and first and second chrominance signals 13 and 15 (U and V).

The color video signal 12 is received by a chrominance extractor 14 that receives the uncompressed color video signal 12 and extracts the chrominance frames 16. Each chrominance frame 16 consists of a video frame providing only the extractive chrominance signal 13 or 15. In the preferred embodiment, chrominance signal 13 is used; however, chrominance signal 15 may also be used. With uncompressed video in the Y′UV format, the chrominance extractor 14 may simply be an electrical switch connected to the appropriate chrominance signal 13 or 15.

The chrominance frame 16 is then received by a change detector 20 that processes the chrominance frames 16 and outputs a scene change signal 18 indicating whether there has been a scene change.

Referring now to FIG. 2, the change detector 20 may receive the chrominance frames 16 at a frame buffer 22 that may store sequential chrominance frames 16 for simultaneous processing. The frame buffer 22 outputs sequential chrominance frames (e.g. Frameₙ₋₁, Frameₙ, and Frameₙ₊₁) so that for each frame in the video (Frameₙ) the preceding and following frame may also be analyzed.

Specifically, the frame buffer 22 may output a sequential first chrominance frame 24, second chrominance frame 26 and third chrominance frame 28. A first subtractor 30 receives first chrominance frame 24 and second chrominance frame 26 and subtracts the second chrominance frame 26 from first chrominance frame 24 to output a first difference frame 34. A second subtractor 32 receives second chrominance frame 26 and third chrominance frame 28 and subtracts the third chrominance frame 28 from the second chrominance frame 26 and outputs a second difference frame 36. The subtractions are performed on a pixel-by-pixel basis so that the first difference frame 34 and second difference frame 36 have the same image size as the received frames 24-26.

Each difference frame 34 and 36 is received by a corresponding magnitude extractor taking the absolute value of every pixel in the frames 34 and 36 to produce a first absolute difference frame 42 corresponding to the difference frame 34 and a second absolute difference frame 44 corresponding to the difference frame 36.

The absolute difference frames 42 and 44 maybe describe mathematically by the following equations (1) and (2):

Fₙ₋₁(x,y)=|Cₙ₋₁(x,y)−Cₙ,(x,y)″for all x,y (1)

Fₙ(x,y)=|Cₙ(x,y)−Cₙ₊₁(x,y)| for all x,y (2)

where Fₙ₋₁(x,y) is the absolute difference frame 42 and Fₙ₋₁(x,y) is the absolute difference frame 44, Cₙ₋₁(x,y) is chrominance frame 24, Cₙ(x,y) is chrominance frame 26, Cₙ₊₁(x,y) is chrominance frame 28, n is an index indicating the time/position of the chrominance frames in the video sequence, and x and y are the coordinates of the video elements (for example, pixels) within the frames. For example, x may have values 0 to 639 and y may have values 0 to 479 for a frame that is 640 elements in width and 480 elements in height.

The first absolute difference frame 42 is then received by a first entropy processor 50 and the second absolute difference frame 44 is received by a second entropy processor 60. These entropy processors will measure the amount of difference in the information between successive chrominance frames 24, 26, and 28 as will be described.

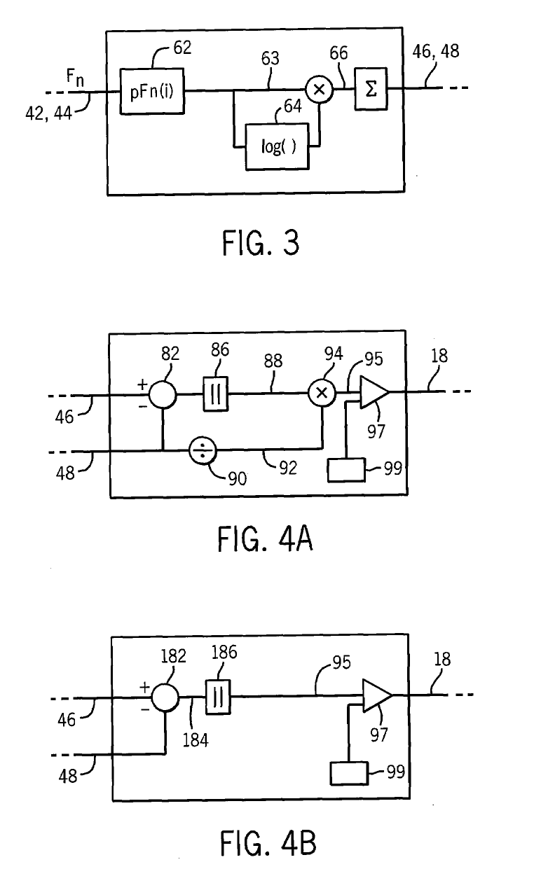

Referring now to FIG. 3, the entropy processors, 50 and 60 measure the entropy of the nth absolute chrominance difference frame per the following equation (3):

$${H}_{n} = - {\sum }_{i = 0}^{255} \frac{p {F}_{n} ( i )}{log ( p {F}_{n} ( i ) )} \qquad ( 3 )$$

where Fₙ are the absolute difference frames 42 and 44, pFₙ(i) is the probability of a specific element value i in frame Fn where i has the range of values, typically, from 0 to 255, and wherein Hₙ are entropy outputs 46 and 48 of the entropy processors 50 and 60, respectively.

The entropy outputs 46 and 48, respectively, of the entropy processor 50, 60 are then received by an entropy measurement differencer 80 which determines changes in the entropy in successive frame pairs to output the scene change signal 18.

Referring now to FIG. 4, each entropy processor 50 and 60 receives the absolute difference frames 42 or 44 then computes the probability of all values of elements of the absolute difference frame 42 and 44, for example, by creating a histogram of pixel values of the particular absolute difference frame 42 or 44. For example, if the possible chrominance values of a pixel i range from 0 to 255, the probability of each possible value may provide an output probability signal 63 as a function relating probability to pixel value.

The probability signal 63 is then received by a companding device 64 that computes and outputs the logarithm of the probability 65. The probability signal 63 is also received by a multiplier that multiplies probability signal 63 with the logarithm of the probability 65 producing as an output the product 68. A summing component 70 receives and sums the products 68 over the range of i to produce a single entropy value. In one embodiment, the summing component 70 would sum 256 separate probability values corresponding to each possible pixel value. The summing component 70 produces the value output Hₙ described above represented by entropy outputs 46 and 48.

Turning now to FIG. 4a, a first embodiment of the differencer 80, receives the first entropy output 46 and second entropy output 48 at a subtractor 82 which subtracts the second entropy output 48 from the first entropy output 46 outputting a difference signal 84. Magnitude extractor 86 takes the absolute value of difference signal 84 producing absolute value signal 88. The second entropy output 48 is also received by an inverting component 90 which inverts the second entropy output 48 producing output signal 92. The output signal 92 and the absolute value signal 88 from the magnitude extractor 86 are multiplied together by multiplier 94 to provide a change output 95 received by a comparator 97 which compares the output from the multiplier to a change reference value 99 to produce the scene change signal 18 when the output from the multiplier is above the change reference value 99. Scene change signal 18 indicates a change in video scenes.

Turning now to FIG. 4b, a second embodiment of the differencer 80 receives first entropy output 46 and second entropy output 48 at subtractor 182 and subtracts the second entropy output 48 from the first entropy output 46 outputting a difference signal 184. Magnitude extractor 186 takes the absolute value of difference signal 184 and provides a change output 95 as before received by a comparator 97 which compares the output from the multiplier to a change reference value 99 to produce the scene change signal 18 when the output from the multiplier is above the change reference value 99.

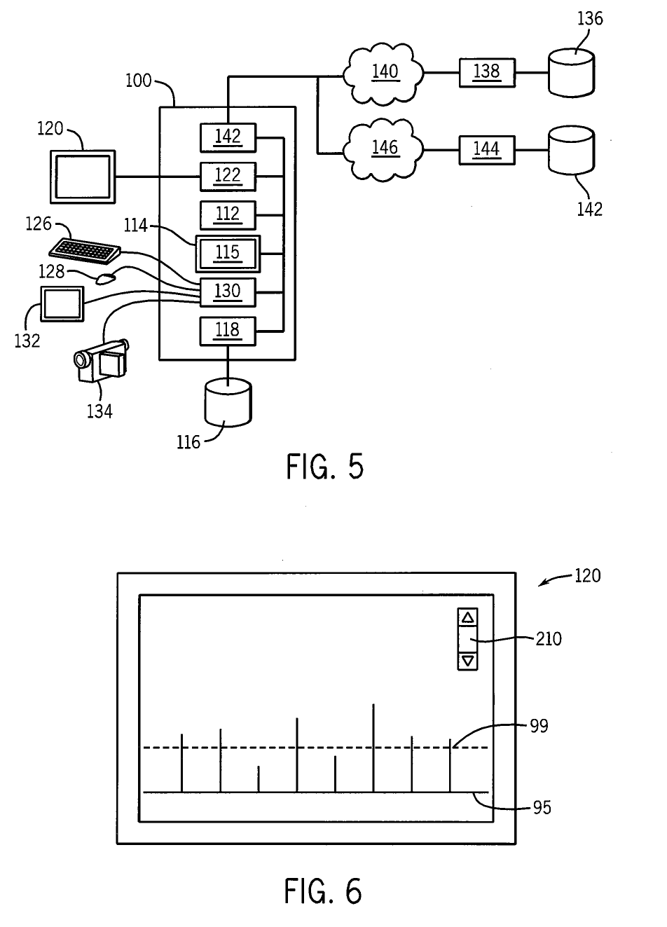

Turning now to FIG. 5, the change reference value 99 may be set manually, for example, by providing a display 120 that shows the change output 95 together with the change reference value 99 allowing the user to set the change reference value 99 visually, for example, through the use of a control 210. Alternatively the change reference value 99 may be set automatically, for example, to produce a certain number of scene changes per unit time or over the length of the work, or to produce a scene change rate that smoothly changes as a function of time reflecting variations in the pace of the video. Manual entry of templates for different types of video may be provided for this purpose.

Referring now to FIG. 6, the present invention may be implemented as an executable program stored on a computer system optionally operating in a network environment. Computer 100 may be any computing device including, but not limited to, personal digital assistants, mobile telephones, desktop personal computers, portable computers, computer workstations, etc. Processor 112 may be any computer processor capable of executing video scene change detector 10. When executing the video scene change detector, the processor 112 utilizes memory 114 holding the program of the present invention 115 and information may be read from and written to the local storage device 116 utilizing storage controller 118. Storage device 116 may be any device that includes any processor readable media such as a hard drive, CD, DVD, flash memory unit, etc. The processor 112 may provide outputs to the display device 120 utilizing display controller 122. A user accesses computer 100 via any computer input device such as, for example, keyboard 126 and mouse 128 which are coupled to the processor 112 by an input/output I/O controller 130.

The video scene change detector may utilize uncompressed color video from local storage device 116 via storage controller 118, video playback device 132 via input/output controller 130, video capture device 134 via input/output controller 130, local network storage device 136 on local network computer system 138 via intranet 136 accessed with network access unit 142, and remote server storage device 142 on remote computer system 144 via Internet 146 access with network access unit 142. Although only one local network computer system and one remote computer system 144 are depicted, multiple local computer systems and multiple remote computer systems may be connected to the intranet 140 and the Internet 146, respectively. The network access unit 142, display controller 122, processor 112, memory 114, input/output controller 130, and storage controller 118 are all connected to one another and communicate with one another over bus 148. Although only one bus is depicted, multiple buses may be used in computer 100.

It is specifically intended that the present invention not be limited to the embodiments and illustrations contained herein, but include modified forms of those embodiments including portions of the embodiments and combinations of elements of different embodiments as come within the scope of the following claims. The term “entropy” should be considered synonymous with measuring information content or information complexity and is not to be limited to the descriptions contained herein.

What is claimed is:

1. A scene change detector for video comprising:
an input receiving a color video signal of time ordered frames of pixels providing luminance and chrominance components;
a chrominance extractor extracting a selected chrominance component from the frames to produce chrominance frames without luminance information; and
an information change detector receiving a sequence of chrominance frames to output a scene change signal based on changes between sequential chrominance frames.

2. The scene change detector of claim 1 wherein the information change detector provides a measure of the information content of a difference between sequential frames.

3. The scene change detector of claim 2 wherein the measure of information content is entropy.

4. The scene change detector of claim 1 wherein the information change detector provides an output that is a function of a change in changes of sequential chrominance frames.

5. The scene change detector of claim 4 wherein the change in changes of sequential chrominance frames takes a difference between sequential chrominance frames, determines the information content of the difference, and determines the difference in the information content of the difference.

6. The scene change detector of claim 1 wherein the chrominance signal is a U chrominance signal.

7. The scene change detector of claim 1 wherein the color video signal is uncompressed.

8. The scene change detector of claim 1 wherein the information change detector further includes a comparator comparing a change in a value of a function of information content of a difference between frames to a threshold value set to provide a predetermined number of scene changes per a time interval.

9. The scene change detector of claim 8 further including a display for displaying the threshold value juxtaposed on a time plot of the function and including a control for varying the threshold value to visually move the threshold value with respect to the plot of the function.

10. A method of detecting scene changes in a color video signal of time ordered frames of pixels providing luminance and chrominance components, the method comprising the steps of:
(1) extracting a chrominance component from the frames to produce chrominance frames without luminance information; and
(2) detecting a change in a measure of information content in sequential chrominance frames to provide an output indicating a change of scene.

11. The method of claim 10 wherein the detecting measures the information content of a difference between sequential frames.

12. The method of claim 11 wherein the measure of information content is entropy.

13. The method of claim 10 wherein the chrominance signal is a U chrominance signal.

14. The method of claim 10 wherein the detecting measures a function of a change in changes of sequential chrominance frames.

15. The method of claim 14 wherein the change in changes of sequential chrominance frames takes a difference between sequential chrominance frames, determines the information content of the difference, and determines the difference in the information content of the difference.

16. The method of claim 10 wherein the color video signal is uncompressed.

17. The method of claim 10 wherein the detecting compares a change in a value of a function of information content of a difference between frames to a threshold value set to provide a predetermined number of scene changes per a time interval.

18. The method of claim 17 further including the step of displaying the threshold value juxtaposed on a time plot of the function and varying the threshold value to visually move the threshold value with respect to the plot of the function.
